(19) United States
(12) Patent Application Publication
(10) Pub. No.: US 2008/0029534 A1
(43) Pub. Date: Feb. 7, 2008

(54) Method and Device for Preventing Thievery, Wastage and Undesired Handling of Valuable Coupons

(76) Inventor: Stefan Borgryd, Kalmar (SE)

Correspondence Address: DICKSTEIN SHAPIRO LLP, 1825 EYE STREET NW, Washington, DC, 20006-5403, US

(21) Appl. No.: 11/630,284

(22) PCT Filed: Jun. 21, 2005
(86) PCT No.: PCT/SE05/00976

§ 371 Date: Dec. 20, 2006

(30) Foreign Application Priority Data
Jun. 22, 2004 (SE) 0401608-5

(51) Int. Cl. G07F 11/00

(52) U.S. Cl. 221/154

(57) ABSTRACT

The present invention refers to a method and a device for preventing thievery, wastage and undesired handling of valuable coupons (1) in the form of so called “lucky lots”, “scraping lots”, stamps or the like in connection with selling of the same and/or storage of the same in another location in a shop. The valuable coupons (1) are stored in at least one in any way burglary protecting storage box (2) having at least one lock (3) and at least one feeding means (13), one of these being electronically guided of a pre-programmed computer/processor (8) existing in a cash register (4) via at least one communication way (7), whereby when a customer (5) is served by a salesman (12) information about a desired quantity, amount and type of valuable coupon (1) is in a first step feed in on payment to the cash register (4), which in a second step is registered of said computer/processor (8), which when the total payment is paid and acknowledged in said cash register (4) in a third step transfers this information about the desired quantity, amount and type of valuable coupons (1) to the computer/processor (8), an activating being done via the communication way (7) to at least one of said storage boxes (2) to open up the lock (3) and/or to activate the feeding means (13), whereupon in a fourth step the one or those desired valuable coupons (1) is/are made accessible.

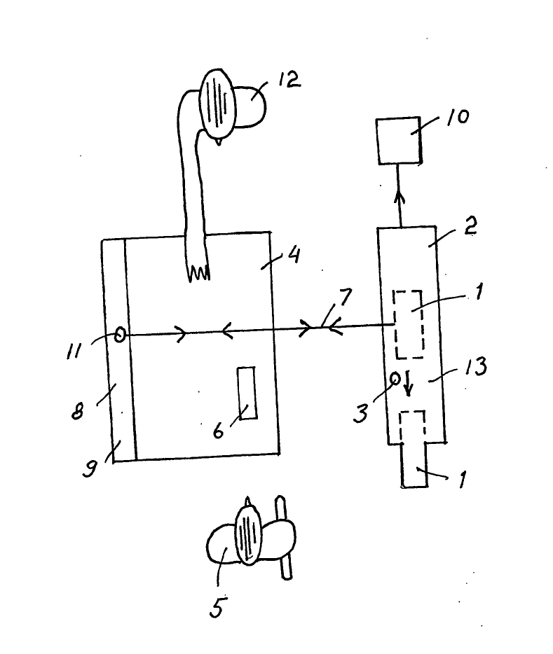

The present invention refers to a method and a device for preventing thievery, wastage and undesired handling of valuable coupons in connection with selling of the same. The valuable coupons are stored in burglary protecting storage boxes having their locks and feeding means electronically guided via a communication way from a pre-programmed computer/processor connected to a cash register, When a customer has paid the total payment, which is acknowledged in said cash register an activating being done via the communication way to open up the lock or to activate the feeding means, whereupon the desired valuable coupons are made accessible for the customer or the salesmen.

Existing structures on the market today use different types of solutions for storage, handling and delivering of said valuable coupons such as triss lots, scraping lots, stamps and so on, which are sold in shops, e.g. department stores, self service shops, petrol stations, tobacco shops, newspaper shops, kiosks of different kind and so on. The valuable coupons often lie accessible for salesmen and other personnel in manually locked or unlocked storage spaces such as boxes and cupboards, storage bags or unlocked bags. This is a growing problem, when a large quantity of valuable coupons disappears. Another problem is that a control does not exist about which valuable coupons are missed, if not a great work is done to manually control these. Without this control you do not know which coupons which have been disappeared or at which time or which quantity which has got lost. Today the situation is so bad that during selling of valuable coupons that many customers handles such coupons during economic loss.

One object of the present invention is to solve those problems existing in the above mentioned structures by storing the valuable coupons in storing boxes intended to be used for the actual purpose so that the valuable coupons are fed out from the same not until they are paid for during an activation from a computer/processor via an electronic communication way intended for that purpose.

Thanks to the present invention a method and a device have been provided which are preventing thievery, wastage and undesired handling of valuable coupons in the form of so called “lucky lots”, “scraping lots”, stamps or the like in connection with selling of the same and/or storage of the same in another location in a shop.

The invention will now be described in more detail below with help of a preferred embodiment example with reference to the accompanying drawing, on which a diagram straight from above is illustrated, which shows how a device according to the invention is built up in realizing the inventive method.

As can be seen from the drawing, here is shown a device for carrying out the method for preventing thievery and undesired handling of valuable coupons 1, which are stored in a burglary protecting storage box 2 having a lock 3 and a feeding means 13, which are electronically guided by a computer/processor 8 existing in a cash register 4. Said computer/processor 8 is electronically connected via an electronic communication way 7. A customer 5 is bying a valuable coupon 1 from a salesman 12, which feeds in information about quantity and type and up to which price said valuable coupon is bought into the cash register 4. The feeding means 13 feeds out the or those desired valuable coupons 1 to the customer 5 after the complete acknowledged payment. The communication way 7 is accessible via at least one pre-selected computer-door 11 in the computer/processor 8. Information about a desired quantity and type of valuable coupon 1 and up to what price is stored in the memory 9 of the computer/processor 8, which also can be a separate special memory 10, which only is accessible for intended personal, e.g. by using at least one pre-selected code.

The method according to the invention is carried out by a device described above, at which the valuable coupons are stored in said burglary protecting storage boxes 2, which are located in the shop within reach for a salesman 12 near to a cash register 4. When a customer 5 in a first step shall pay a desired quantity and type of valuable coupon 1 the salesman 12 feeds in that information and to which amount to the cash register, which in a second step is registered by the computer/processor 8, whereupon the same, when a complete payment is carried out and acknowledged in the cash register 4, in a third step transmits this information about desired quantity and type of valuable coupons and to which amount to the computer/processor 8. Then an activation is carried out via the communication way 7 to a pre-selected storage box 2 to open up the lock and to activate the feeding means 13. Then in a fourth step the desired valuable coupons are made accessible for the customer, whereupon the storage box 2 again is locked. Should the customer also buy other products also these will be fed into the cash register 4 in the first step and registered by the computer/processor 8, so that the second step according to what is stated above, is started and later on the third and fourth step is carried out to its end. The valuable coupons 1 are in other words accessible only a short time for each customer after that a payment have been made and that is why no unauthorized person can take care of said valuable coupons. The security can be further enhanced according to the invention by that the communication way 7 is only accessible via the pre-selected computer-door 11 in the computer/processor. This is done by activating the same by a pre-selected code. According to the invention it is also possible to derive and trace which valuable coupons, which have been stolen by that these are electronically stored in a pre-selected order. This information can be easy to fetch in relation to time and date. Then, you can find information about desired quantity and type of valuable coupon and to which price the same is bought in the memory 9 of the computer/processor. This memory 9 can as mentioned above consist of a separate special memory 10, which only is accessible by intended personal. Then fed out quantity of sold, valuable coupons can be controlled in relation to those valuable coupons filled up in the storage boxes with reference to time and date and quantity. In a preferred embodiment of the invention the feeding means 13 is working mainly as a note feeder in a cash dispenser. During bying of the valuable coupons then the desired quantity and type and the actual price is fed into the cash register by button pressing on a key-board or by a line code reader or a similar method. The greatest advantages with the invention are in other words that a safe storage method has been created for the valuable coupons, which in this way cannot be accessible for unauthorized persons, since they only can be made accessible for the customer after an acknowledged, complete payment. Further stored valuable coupons can be controlled in relation to sold coupons what concerns quantity, type, time and to what price and in this way derive attempts for stealing, loss or other unauthorized handling of the valuable coupons.

1. A method for preventing thievery, wastage and undesired handling of valuable coupons (1) in the form of so called “lucky lots”, “scraping lots”, stamps or the like in connection with selling of the same and/or storage of the same in another location in a shop, characterized in that said valuable coupons (1) are stored in at least one in any way burglary protecting storage box (2) having at least one lock (3) and at least one feeding means (13), one of these being electronically guided of a pre-programmed computer/processor (8) existing in a cash register (4) via at least one communication way (7), whereby when a customer (5) is served by a salesman (12) information about a desired quantity, amount and type of valuable coupon (1) is in a first step feed in on payment to the cash register (4), which in a second step is registered of said computer/processor (8), which when the total payment is paid and acknowledged in said cash register (4) in a third step transfers this information about the desired quantity, amount and type of valuable coupons (1) to the computer/processor (8), an activating being done via the communication way (7) to at least one of said storage boxes (2) to open up the lock (3) and/or to activate the feeding means (13), whereupon in a fourth step the one or those desired valuable coupons (1) is/are made accessible.

2. A method according to claim 1, characterized in that the customer (5) is also bying other articles in the first step, all articles being fed in to the cash register (4) and are registered of the computer/processor (8), whereupon the second step is started and later on the third step and fourth step are brought to an end.

3. A method according to claim 1, characterized in that the communication way (7) is accessible via at least one pre-selected computer-door (11) in the computer/processor (8) preferably by that the same is activated with a pre-selected code.

4. A method according to claim 1, characterized in that the valuable coupons (1) are stored in said storage box (2) in a pre-selected order.

5. A method according to claim 1, characterized in that the information about the desired quantity and type of valuable coupon (1) is stored in the memory (9) of the computer/processor (8), said information an be fetched regarding to time and date, so that delivered quantity of sold valuable coupons (1) according to the memory (9) can be controlled in relation to the valuable coupons (1) refilled in the storage box/boxes (2) with respect to time and date and quantity, said information also can be stored in said memory (9) and/or be separately documented in another place.

6. A method according to claim 1, characterized in that the feeding means (13) is working mainly or partly as a bill feeder in a cash dispenser.

7. A method according to claim 1, characterized in that the feeding in of a quantity and type of valuable coupon (1) desired to said cash register (4) is done by button pressing on a button table and/or by aid of an line code reader or another similar method.

8. A method according to claim 1, characterized in that the memory (9) is a special memory (10), which is only accessible by salesmen intended to use the same, e.g. by using at least one pre-selected code.

9. A device for using the method for preventing thievery, wastage and undesired handling of valuable coupons (1) in the form of so called “lucky lots”, “scraping lots”, stamps or the like in connection with selling of the same and/or storage of the same in another location in a shop, characterized in that said valuable coupons (1) are stored in at least one in any way burglary protecting storage box (2) having at least one lock (3) and at least one feeding means (13), one of these being electronically guided of a pre-programmed computer/processor (8) existing in a cash register (4) via at least one communication way (7), whereby when a customer (5) is served by a salesman (12) information about a desired quantity, amount and type of valuable coupon (1) is in a first step feedable in on payment to the cash register (4), which in a second step is able to be registered of said computer/processor (8), which, when the total payment has been paid and acknowledged in said cash register (4) in a third step transfers this information about the desired quantity, amount and type of valuable coupons (1) to the computer/processor (8), an activating being done via the communication way (7) to at least one of said storage boxes (2) to open up the lock (3) and/or to activate the feeding means (13), whereupon in a fourth step the one or those desired valuable coupons (1) is/are made accessible.
